(19) United States
(12) Patent Application Publication
(10) Pub. No.: US 2002/0089171 A1
(43) Pub. Date: Jul. 11, 2002

(54) Business card system

(76) Inventor: Steve R. Silvestre, Scottsdale, AZ (US)

Correspondence Address: STONEMAN LAW OFFICES, LTD, 3113 NORTH 3RD STREET, PHOENIX, AZ, 85012, US

(21) Appl. No.: 09/754,990

(22) Filed: Jan. 5, 2001

(51) Int. Cl. B42D 15/00

(52) U.S. Cl. 283/61

(57) ABSTRACT

A business card which includes both a printed business card as well as associated labels removably attached to the business card. The business card, a laminate of card stock with label stock, contains removable labels with adhesive backing and a perforated tear-off end tab. The business card information on a card portion of the card stock is similar to the information on the associated labels/tab. The removable labels/tab are sized such that they accommodate use as file folder labels, index card file labels, address labels, or other such business information transfer applications.

### BACKGROUND

This invention relates to providing a system for improved business card information transfer. More specifically, this invention relates to a business card system which has both a printed business card portion (with normal business information) and associated label portions (with the same or similar information) removably attached to the business card portion. The removable labels are sized such that they accommodate use as file folder labels, index card file labels, address labels, and/or any of a variety of other similar uses. The business card system contains both removable labels with adhesive backing and a tear-off-tab label (suitable, e.g., for placement within an identifying insert of a file folder) with or without adhesive backing.

Typically, business cards are handed out by a user to a business associate to transfer valuable information as to who the user is and information on how to contact the user. The business associate generally will have to transfer the business card information to other file cards, file folders, address books, etc. This transfer of the business card information takes up valuable time. Thus, it would be beneficial for a business card, even while maintaining its use as a business card, to include removable portions having business card information but usable directly with other office information systems without the need for the usual slow copying and/or other transfer means.

### OBJECTS OF THE INVENTION

A primary object and feature of the present invention is to provide a system for providing removable labels to transfer business card information to file cards, file folders, address books, etc., while maintaining the use of the business card for its own purposes.

It is a further object and feature of the present invention to provide such a system which provides a method for making such business cards in an efficient and relatively inexpensive manner.

A further primary object and feature of the present invention is to provide such a system which is efficient, inexpensive, and handy. Other objects and features of this invention will become apparent with reference to the following descriptions.

### SUMMARY OF THE INVENTION

According to a preferred embodiment of the present invention, this invention provides a business card system including at least one business card comprising: a card stock portion being defined by a first exterior edge and having a card first side; and a card second side; and a label stock portion being defined by a second exterior edge and having a label first side; and a label second side; wherein such card first side comprises entirely a printable surface; wherein such card second side comprises entirely a release surface; wherein such label first side comprises entirely an adhesive surface; wherein such label second side comprises entirely a printable surface; wherein such card stock portion and such label stock portion comprise a card laminate wherein such card second side is adjacent such label first side, wherein such label first side is removably adhered to such card second side, and wherein such first exterior edge and such second exterior edge are co-extensive, and wherein such label stock portion comprises at least two discrete areas each defined by an exterior entirely-cut edge.

It also provides such a system wherein: such card first side comprises indicia indicating business-card first business information; and each such discrete areas of such label second side comprises indicia indicating second business information; wherein such first business information and such second business information comprise similar information. And it provides such a system wherein an edge portion of such card laminate comprises a perforated tab comprising indicia indicating third business information and structured and arranged to be detached along such perforation from such card laminate.

Further, it provides such a system wherein such first business information and such third business information comprise similar information. And, it provides such a system wherein a first such discrete area is structured and arranged to adhere to an address book. Even further, it provides such a system wherein a second such discrete area is structured and arranged to adhere to an index card file system. Also, it provides such a system wherein such perforated tab is structured and arranged to be affixed with a file folder tab. And, it provides such a system wherein a label stock portion of such perforated tab is structured and arranged to be used, after such perforated tab has been torn off such business card, to adhere to a file folder tab.

Still further, it provides such a system wherein a label stock portion of such perforated tab is structured and arranged to be used, after such perforated tab has been torn off such business card, to adhere to a file folder tab. And even further, it provides such a system wherein such first printed information comprises a business card arrangement including a person's name, a company address, a phone number and associated contact data.

Moreover, it provides such a system wherein such card laminate is rectangular-shaped. And, it provides such a system wherein a first such discrete area is structured and arranged to adhere to an address book. Also, it provides such a system wherein a second such discrete area is structured and arranged to adhere to an index card file system.

According to another preferred embodiment of the present invention, this invention provides a method of making a business card comprising the steps of: providing a roll of card stock having a printable surface on a first side of such card stock and a release surface on a second side of such card stock and; providing a roll of label stock having a first side and having a second side with a printable surface; setting up such rolls to unwind to laminate such second side of such card stock to such first side of such label stock; spraying an adhesive onto such first side of such label stock as such roll of label stock unwinds, thereby creating an adhesive layer on such label stock; laminating such card stock to such label stock so that such adhesive layer adjoins such release surface, thereby forming a continuous laminate; and cutting such continuous laminate into laminated sheets large enough to be used to make by further cutting a plurality of business cards each comprising a first area.

It also provides such a method further comprising the step of: kiss-cutting each such laminated sheet all the way through the label stock so that each such first area includes at least two discrete label-portion areas each defined by an exterior entirely-cut edge. Additionally, it provides such a method further comprising the step of perforating each such laminated sheet so that each such first area includes at least one tear-off end tab area. And, it provides such a method further comprising the step of: printing indicia on both sides of each such laminated sheet. Even additionally, it provides such a method further comprising the step of printing indicia on both sides of each such laminated sheet.

According to yet another preferred embodiment of the present invention, this invention provides a laminated sheet comprising: at least four layers in the following order from a first side to a second side: a card stock layer, a release surface layer, an adhesive layer, a label stock layer; wherein both such first side and such second side comprise printed surfaces. And, it provides such a laminated sheet wherein: such label stock layer has been cut through to comprise at least two discrete label-portion areas each defined by an exterior entirely-cut edge; and at least one end of such laminated sheet comprises perforations permitting a tear-off end tab.

### BRIEF DESCRIPTION OF THE DRAWINGS

FIG. 1 is a perspective view of the first side of the business card of the instant business card system illustrating the business card portion and a removable file folder label portion according to a preferred embodiment of the present invention.

FIG. 2 is a perspective view of the second side of the business card illustrating removable labels according to a preferred embodiment of the present invention.

FIG. 3 is a perspective view of the second side of the business card further illustrating the removable labels, and their potential uses, according to a preferred embodiment of the present invention.

FIG. 4 is a diagrammatic view of preferred steps, illustrating the steps of spraying, laminating, and cutting into large sheets, in the method of making business cards according to a preferred embodiment of the business card system of the present invention.

FIG. 5 is a partial perspective view of another preferred step, illustrating the step of “kiss-cutting” around the label areas of the label stock of the large sheet, in the method of making the business card according to a preferred embodiment of the present invention.

FIG. 6 is a partial perspective view of yet another preferred step, illustrating the step of perforating the card laminate of the large sheet so that each to-be-cut card will have a removable end tab, in the method of making the business card according to a preferred embodiment of the present invention.

FIG. 7 is a partial perspective view of still another preferred step, illustrating the step of printing both sides of the large sheet in the areas of the to-be-cut cards, in the method of making the business card according to a preferred embodiment of the present invention.

FIG. 8 is a partial perspective view of a final preferred step, illustrating the cutting of the large sheet into individual business cards, in the business card system according to a preferred embodiment of the present invention.

FIG. 9 is a diagrammatic sectional view illustrating the material layers of the preferred business card according to a preferred embodiment of the business card system of the present invention.

### DETAILED DESCRIPTION OF THE BEST EMBODIMENTS OF THE INVENTION

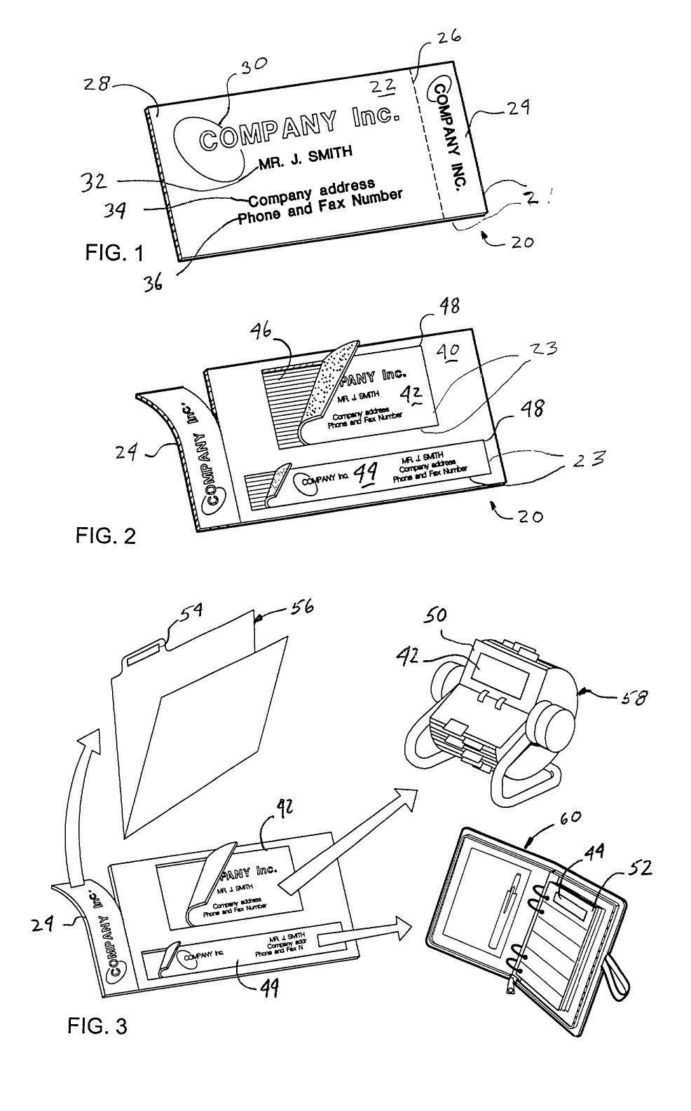

FIG. 1 is a perspective view of the first side 22 (embodying herein a card first side) of the business card 20 of the business card system according to a preferred embodiment of the present invention, illustrating a business card portion 28 and a removable perforated tab portion 24. FIG. 2 is a perspective view of the second side 40 (embodying herein a card second side) of the business card 20 illustrating removable labels 42 and 44 according to a preferred embodiment of the present invention. Business card 20 preferably covers a rectangular area of card stock, i.e. it comprises a card stock portion being defined by a first exterior edge 21; and labels 42 and 44 preferably each cover a rectangular area of label stock, i.e., each comprises a label stock portion being defined by a second exterior edge 23, preferably, as shown, wherein such label stock portion comprises at least two discrete areas each defined by an exterior entirely-cut edge. FIG. 3 is a perspective view of the second side 40 of the business card 20 further illustrating the removable labels 42 and 44 and tear-off tab portion 24, and their potential uses, according to a preferred embodiment of the present invention.

A preferred embodiment of the business card 20 comprises both a printed business card portion 28 as well as associated labels 42 and 44 and perforated tab 24 removably attached to portions of the business card 20. The business card 20 contains both removable labels 42 and 44 with adhesive backing and perforated tab 24 (without adhesive backing). FIG. 1 illustrates the first side 22 of the business card 20 according to a preferred embodiment of the present invention. The first side 22 of the business card 20 is comprised of a more-or-less standard-sized business card portion 28 and a perforated tab portion 24. In one preferred embodiment, business card portion 28 is sized three and one-half inches wide by two inches high and perforated tab portion 24 is sized two inches high by one-half inch wide. Preferably, the business card 20 is a rectangular shaped card (embodying herein wherein such card laminate is rectangular-shaped). Perforated tab portion 24 is preferably cut with a perforation 26 such that the perforated tab portion 24 may be removed, as is further illustrated in FIG. 2, leaving the business card portion 28 intact. Preferably, the business card 20 has printed indicia on the business card portion 28 which is useful and informative about a company or product (embodying herein such card first side comprising indicia indicating business-card first business information). One such preferred indicia includes a business logo 30, a contact name 32, a contact address 34, contact phone numbers 36 and other pertinent information (embodying herein wherein such first printed information comprises a business card arrangement including a person's name, a company address, a phone number and associated contact data). Obviously, to those knowledgeable in the art, there are a large number of other preferred embodiments of the indicia that may be applied to the business card 20 and this description is not intended to limit such.

FIG. 2 illustrates a perspective view of the second side 40 of the business card 20 illustrating removable labels 42 and 44 according to a preferred embodiment of the present invention. Preferably, the removable labels 42 and 44 (each covering and having a discrete area, as shown) have printed indicia on them similar to the information contained in the business card portion 28 which is useful and informative about a company or product (embodying herein that each such discrete area of such label second side comprises indicia indicating second business information; wherein such first business information and such second business information comprise similar information).

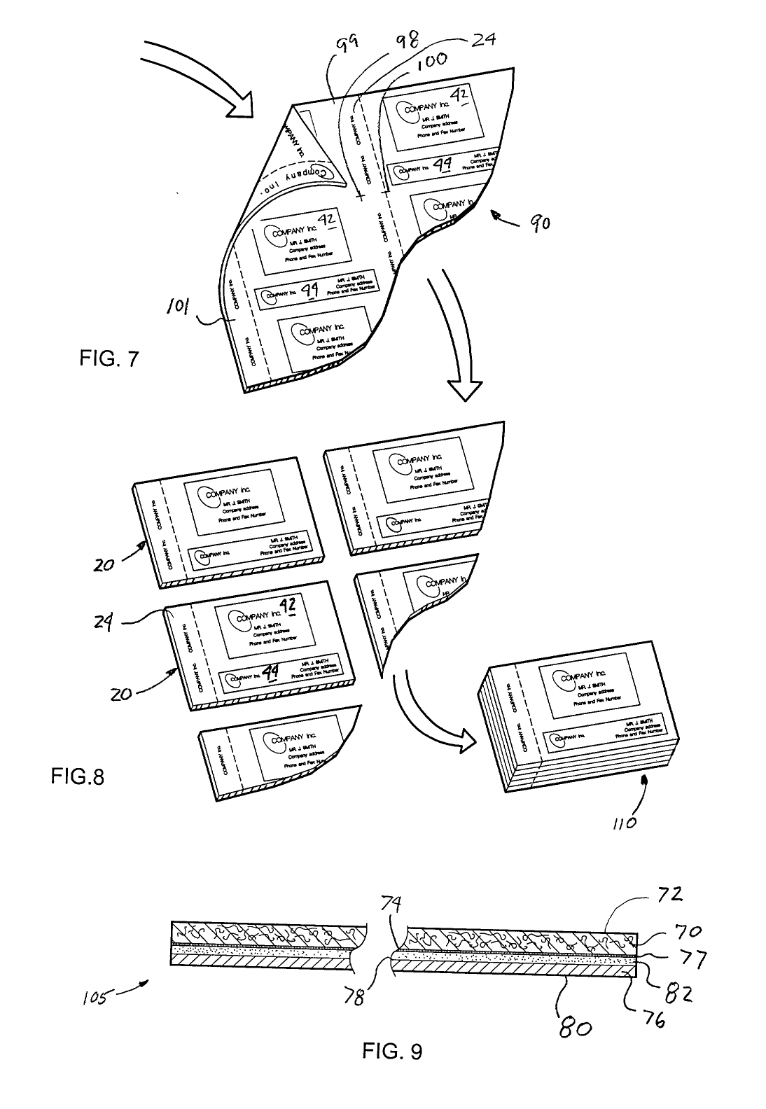

FIG. 3 further illustrates the removable labels 42 and 44, and their potential uses on a file folder 56, a rolling index card file 58, and an address book 60. In the preferred embodiment of the second side 40, label 42 and label 44 are removable labels which have been pre-cut such that they may be easily removed from the releasable surface 46. Such a pre-cut, which penetrates only the label stock 76 (see FIG. 9) is also commonly referred to as a kiss-cut 48 and will be referred to as such herein. The method of making the business card 20 will be explained below in greater detail and the release surface 46 will be further identified. Preferably, label 42 is sized such that it will fit on common index card file cards 50 (embodying herein wherein a second such discrete area is structured and arranged to adhere to an index card file system). In one preferred embodiment, label 42 is sized two and three-eighths inches wide by one and one-eighth inches high. In one preferred embodiment label 44 is sized three and three-eighths inches wide by one-half inches high. Preferably, label 44 is sized such that it will fit onto a common address book or appointment book pages 52, such as those illustrated in FIG. 3 (embodying herein wherein a first such discrete area is structured and arranged to adhere to an address book). Perforated tab portion 24 is preferably sized such that, when removed by tearing it off the card, it will fit into common file folder tabs of the type commonly found at office supply stores and made to fit onto file folders 56; or, as an option, the label-stock portion of the tab 24 may be lifted off and adhered to a file folder tab (embodying herein wherein such perforated tab is structured and arranged to be affixed with a file folder tab; and wherein a label stock portion of such perforated tab is structured and arranged to be used, after such perforated tab has been torn off such business card, to adhere to a file folder tab), as shown. Preferably, perforated tab portion 24 has printed indicia on it similar to the information contained in the business card portion 28 and labels 42 and 44 (embodying herein that an edge portion of such card laminate comprises a perforated tab comprising indicia indicating third business information and structured and arranged to be detached along such perforation from such card laminate; and wherein such first business information and such third business information comprise similar information).

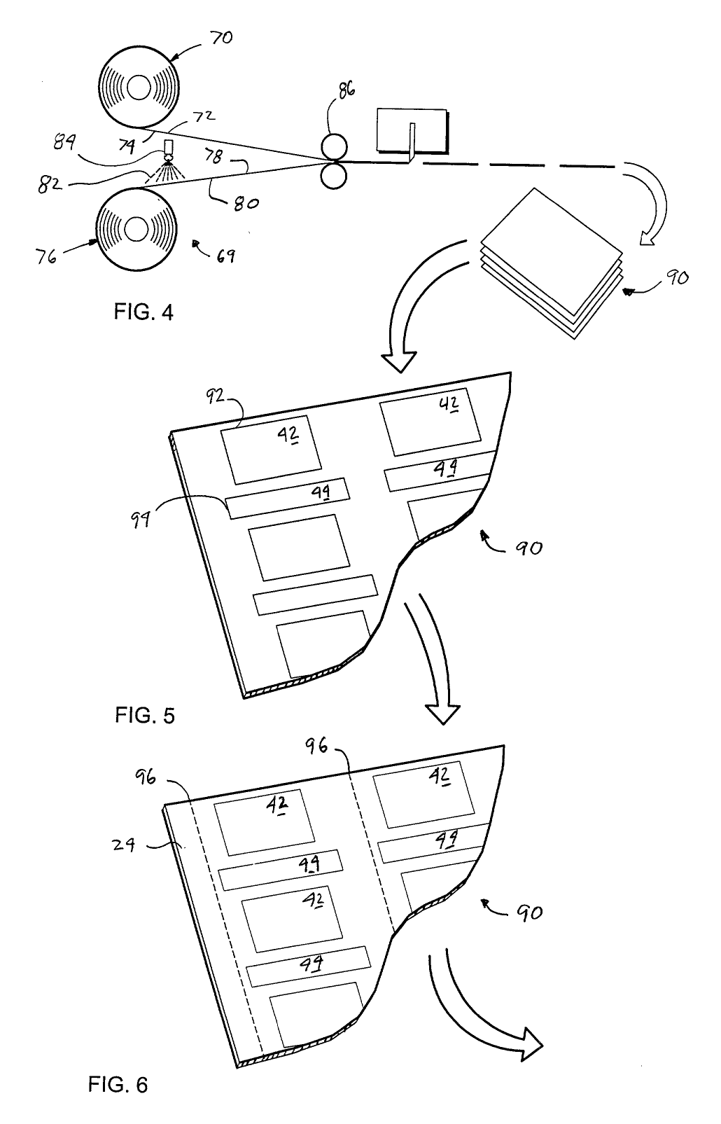

FIG. 4 is a diagrammatic view of preferred steps in the method of making the business card 20 according to a preferred embodiment of the present invention, illustrating the steps of spraying, laminating, and cutting into large sheets. (Those knowledgeable in the art of printable matter, manufacturing business cards and laminating papers will understand that the following description is intended to describe a preferred best embodiment of such method and is not intended to limit, apart from the language of all the claims, the manner in which the business card 20 is manufactured.) Preferably, the first step in manufacturing the business card 20 is to laminate the card stock and label stock together, then cut the laminated stock into workable card stock sheets. The laminating process is preferably accomplished as described below.

A two-sided roll of card stock 70 is placed on the laminating machine 69. Card stock 70 may be any of a variety of paper weights; however, the preferred paper weight is 60-pound stock. Preferably, card stock 70 has a top side 72 that has a standard printable surface (embodying herein wherein such card first side comprises entirely a printable surface) and a bottom side 74 that has a release surface 77 (embodying herein wherein such card second side comprises entirely a release surface) applied to it (the arrangement embodying herein providing a roll of card stock having a printable surface on a first side of such card stock and a release surface on a second side of such card stock). Release surface 77 may be selected by those skilled in the art to perform the necessary function of allowing the labels 42 and 44 to be removably attached to the bottom side 74. Preferably, a two-sided roll of label stock 76 is also placed on the laminating machine. Preferably, label stock 76 has a top side 78 (embodying herein a label first side) that has an adhesive 82 applied (preferably by spraying) prior to laminating (embodying herein wherein such label first side comprises entirely an adhesive surface; and embodying herein the step of spraying an adhesive onto such first side of such label stock as such roll of label stock unwinds, thereby creating an adhesive layer on such label stock), as illustrated by the spray mechanism 84, and a bottom side 80 (embodying herein a label second side) that has a printable label surface (embodying herein wherein such label second side comprises entirely a printable surface; the above arrangement embodying herein the step of providing a roll of label stock having a first side and having a second side with a printable surface). Preferably, adhesive 82 is such that it will removably adhere to the bottom side 74, having the release surface 77, when laminated together. The card stock 70 and the label stock 76 are laminated together by unwinding the rolls of card stock 70 and label stock 76, as illustrated in FIG. 4, (embodying herein setting up such rolls to unwind to laminate such second side of such card stock to such first side of such label stock) and inserted into pinch rollers 86. Pinch rollers 86 may be representative of any machinery that effectively laminates the card stock 70 and the label stock 76 together (this arrangement embodying herein laminating such card stock to such label stock so that such adhesive layer adjoins such release surface, thereby forming a continuous laminate). Subsequent to the laminating, the roll stock is squared and size cut into exact proportions by a cutter 88 into card stock sheets 90 (embodying herein cutting such continuous laminate into laminated sheets large enough to be used to make by further cutting a plurality of business cards each comprising a first area). The preferred sizing of the card stock sheets 90 is thirty-six inches by twenty inches. The preferred sizing will preferably result in multiple cards of the preferred sized business card 20 portions depending on the final sizing of the individual card portions.

The next step in the manufacturing process of the preferred embodiment of the business card 20 is illustrated by FIG. 5. FIG. 5 is a partial perspective view of another preferred step, illustrating the step of “kiss-cutting” around the label areas of the card stock sheet 90, in the method of making the business card 20 according to a preferred embodiment of the present invention. Preferably, the label stock 76 side of the card stock sheets 90 are kiss-cut (i.e., the label stock is clear through, such that the label portion may be lifted and peeled off, without cutting into the card stock below). Shown are the kiss-cuts 92 and 94 (embodying herein kiss-cutting each such laminated sheet all the way through the label stock so that each such first area includes at least two discrete label-portion areas each defined by an exterior entirely-cut edge; and embodying herein such label stock layer has been cut through to comprise at least two discrete label-portion areas each defined by an exterior entirely-cut edge) for labels 42 and 44, described above in FIGS. 1-3. Preferably, the mechanism for cutting the kiss-cuts 92 and 94 is precise and uniform in the cutting process such that each card stock sheet 90 is cut the same. Such cutting is done in well known ways by those skilled in the art of such machinery.

The next step in the manufacturing process of the preferred embodiment of the business card 20 is illustrated by FIG. 6. FIG. 6 is a partial perspective view of yet another preferred step, illustrating the step of perforating the card laminate of the card stock sheet 90 so that each to-be-cut card will have a removable end tab, in the method of making the business card 20 according to a preferred embodiment of the present invention. In this step the card stock sheet 90 is cut with perforation cuts 96. These perforation cuts 96 are cut such that the perforated end 26 of the tear-off perforated end tab 24 is formed from the business card stock sheet 90 (embodying herein perforating each such laminated sheet so that each such first area includes at least one tear-off end tab area; and embodying herein that at least one end of such laminated sheet comprises perforations permitting a tear-off end tab).

The next step in the manufacturing process of the preferred embodiment of the business card 20 is illustrated by FIG. 7. FIG. 7 is a partial perspective view of still another preferred step, illustrating the step of printing both sides of the card stock sheet 90 in the areas of the to-be-cut cards, in the method of making the business card 20. In this step the card stock sheet 90 is printed on both the card stock 70 and the label stock 76 sides (embodying herein printing indicia on both sides of each such laminated sheet). The printing process is well known by those skilled in the art and is not further detailed herein. Preferably, in addition to printing the labels and business card portion, cutting marks 98 and 99 may be printed for assisting in the to-come cutting step in one direction (e.g. longitudinally) and cutting marks 100 and 101 may be similarly printed for cutting in the other direction (e.g. cutting transversely). The cutting marks 98-101 are printed such that when cut along the cutting marks 98-101, the card stock sheet 90 will be divided into individual business cards 20, as illustrated in FIG. 1 and FIG. 2.

The next step in the manufacturing process of the preferred embodiment of the business card 20 is illustrated by FIG. 8. FIG. 8 is a partial perspective view of a final preferred step, illustrating the cutting of the large sheet into individual business cards, in the method of making the business card system. FIG. 8 illustrates the final step as each of the card stock sheets 90 are cut and trimmed along the cutting marks 98-101 such that there are individual business card 20 cards 110. This results in a business card comprised of a card laminate wherein such card second side is adjacent such label first side, wherein such label first side is removably adhered to such card second side, and wherein such first exterior edge and such second exterior edge are co-extensive. The cutting process is well known by those skilled in the art and is not further detailed herein.

FIG. 9 is a diagrammatic sectional view illustrating the material layers of the laminated sheet 105 (embodying herein a laminated sheet) of the business card 20 according to a preferred embodiment of the present invention. Described above and illustrated in FIG. 9 is laminated sheet 105, which comprises four layers as well as two printable surfaces. Card stock 70 (embodying herein a card stock layer) comprising top side 72 (a first side of the laminate) that is a standard printable surface, and a bottom side 74 that has an release surface/layer 77 (embodying herein a release surface layer). Label stock 76 is shown laminated to the release layer. Label stock 76 has a top side 78 that has an adhesive 82 (embodying herein an adhesive layer) applied prior to laminating and a bottom side 80 (a second side of the laminate) that is a printable label surface (embodying herein a label stock layer). The arrangement of the laminated sheet 105 embodies wherein both such first side and such second side comprise printed surfaces.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims.

What is claimed is:

1) A business card system including at least one business card comprising:
a) a card stock portion being defined by a first exterior edge and having
(1) a card first side; and
(2) a card second side; and
b) a label stock portion being defined by a second exterior edge and having
(1) a label first side; and
(2) a label second side;
c) wherein said card first side comprises entirely a printable surface;
d) wherein said card second side comprises entirely a release surface;
e) wherein said label first side comprises entirely an adhesive surface;
f) wherein said label second side comprises entirely a printable surface;
g) wherein said card stock portion and said label stock portion comprise a card laminate
i) wherein said card second side is adjacent said label first side,
ii) wherein said label first side is removably adhered to said card second side, and
iii) wherein said first exterior edge and said second exterior edge are co-extensive, and
h) wherein said label stock portion comprises at least two discrete areas each defined by an exterior entirely-cut edge.

2) The business card system according to claim 1 wherein:
a) said card first side comprises indicia indicating business-card first business information; and
b) each said discrete areas of said label second side comprises indicia indicating second business information;
c) wherein said first business information and said second business information comprise similar information.

3) The business card system according to claim 1 wherein an edge portion of said card laminate comprises a perforated tab comprising indicia indicating third business information and structured and arranged to be detached along said perforation from said card laminate.

4) The business card system according to claim 3 wherein said first business information and said third business information comprise similar information.

5) The business card system according to claim 4 wherein a first said discrete area is structured and arranged to adhere to an address book.

6) The business card system according to claim 5 wherein a second said discrete area is structured and arranged to adhere to an index card file system.

7) The business card system according to claim 6 wherein said perforated tab is structured and arranged to be affixed with a file folder tab.

8) The business card system according to claim 7 wherein a label stock portion of said perforated tab is structured and arranged to be used, after said perforated tab has been torn off said business card, to adhere to a file folder tab.

9) The business card system according to claim 3 wherein a label stock portion of said perforated tab is structured and arranged to be used, after said perforated tab has been torn off said business card, to adhere to a file folder tab.

10) The business card system according to claim 3 wherein said first printed information comprises a business card arrangement including a person's name, a company address, a phone number and associated contact data.

11) The business card system according to claim 3 wherein said card laminate is rectangular-shaped.

12) The business card system according to claim 2 wherein a first said discrete area is structured and arranged to adhere to an address book.

13) The business card system according to claim 12 wherein a second said discrete area is structured and arranged to adhere to an index card file system.

14) A method of making a business card comprising the steps of:
a) providing a roll of card stock having a printable surface on a first side of said card stock and a release surface on a second side of said card stock and;
b) providing a roll of label stock having a first side and having a second side with a printable surface;
c) setting up said rolls to unwind to laminate said second side of said card stock to said first side of said label stock;
d) spraying an adhesive onto said first side of said label stock as said roll of label stock unwinds, thereby creating an adhesive layer on said label stock;
e) laminating said card stock to said label stock so that said adhesive layer adjoins said release surface, thereby forming a continuous laminate; and
f) cutting said continuous laminate into laminated sheets large enough to be used to make by further cutting a plurality of business cards each comprising a first area.

15) The method according to claim 14 further comprising the step of:
a) kiss-cutting each said laminated sheet all the way through the label stock so that each said first area includes at least two discrete label-portion areas each defined by an exterior entirely-cut edge.

16) The method according to claim 15 further comprising the step of:
a) perforating each said laminated sheet so that each said first area includes at least one tear-off end tab area.

17) The method according to claim 16 further comprising the step of:
a) printing indicia on both sides of each said laminated sheet.

18) The method according to claim 15 further comprising the step of:
a) printing indicia on both sides of each said laminated sheet.

19) A laminated sheet comprising:
a) at least four layers in the following order from a first side to a second side
i) a card stock layer
ii) a release surface layer
iii) an adhesive layer
iv) a label stock layer;
b) wherein both said first side and said second side comprise printed surfaces.

20) The laminated sheet according to claim 19 wherein:
a) said label stock layer has been cut through to comprise at least two discrete label-portion areas each defined by an exterior entirely-cut edge; and
b) at least one end of said laminated sheet comprises perforations permitting a tear-off end tab.
